(19) United States
(12) Patent Application Publication
(10) Pub. No.: US 2025/0184713 A1
(43) Pub. Date: Jun. 5, 2025

(54) SYSTEM AND METHOD FOR MAINTAINING A TELECOMMUNICATION EVENT AT A USER EQUIPMENT

(71) Applicant: Samsung Electronics Co., Ltd., Suwon-si, Gyeonggi-do (KR)

(72) Inventors: Sandeep Singh SPALL, Noida UP (IN); Choice CHOUDHARY, Noida UP (IN)

(21) Appl. No.: 19/047,079

(22) Filed: Feb. 6, 2025

Related U.S. Application Data
(63) Continuation of application No. PCT/KR2023/002658, filed on Feb. 24, 2023.

(30) Foreign Application Priority Data
Oct. 19, 2022 (IN) 202211059858

(51) Int. Cl. H04W 8/18; H04W 76/25

(52) U.S. Cl. CPC H04W 8/183; H04W 76/25

(57) ABSTRACT

A method for maintaining a telecommunication event at a user equipment (UE) is disclosed. The method includes: detecting occurrence of an action event at the UE such that a first processor is unavailable; reserving a dedicated space in a memory of the UE to handle the telecommunication event upon detection of the action event; establishing interaction between a communication processor and a second processor using the dedicated space such that the telecommunication event received by the communication processor is transmitted to the second processor; and maintaining the telecommunication event by the second processor.

### CROSS-REFERENCE TO RELATED APPLICATIONS

This application is a continuation of International Application No. PCT/KR2023/002658 designating the United States, filed on Feb. 24, 2023, in the Korean Intellectual Property Receiving Office and claiming priority to Indian Patent Application number 202211059858, filed on Oct. 19, 2022, in the Indian Patent Office, the disclosures of each of which are incorporated by reference herein in their entireties.

### BACKGROUND

### Field

The disclosure relates to the field of mobile communications and, for example, the disclosure relates to system and method for maintaining telecommunication event on always-on content in a device having a low power processor.

### Description of Related Art

Electronic devices have become a central element in human lives. Every day-to-day activity is surrounded by electronic devices and is done with their usage. For example, a smartphone has become an all-time partner for a user. The users are often engaged in operating applications installed on the smartphone and expect the smartphone to at least be operational for basic events such as making or receiving calls, messages, etc.

The smartphones are typically used to provide mobile and wireless communication services to a user across a wireless telecommunication network. The smartphones may allow the user to access network services such as voice calls, data exchange, text messaging, Internet access, or other services. In many instances, emergency calls may also be placed or received on smartphones to allow the user to contact police, fire, or ambulance services over a 911 call. Among others, the smartphone is powered using processors configured in it. The processors are responsible for functioning of the smartphone and enables the smartphone to handle network services.

Part of a great user experience would be to have the smartphone operational for basic network services such as calls, messaging, or any other event of the wireless telecommunication network at maximum times. However, there may be instances when the smartphone may fail to provide even such basic network services despite being present in wireless communication network.

It might be troublesome for the user when the smartphone even with multiple processors may not be able to render basic network services and face issues causing poor user experience.

Some of the issues that might cause the smartphone to be unavailable to provide the most basic of the telecommunication event as mentioned above are, receiving firmware over the air (FOTA) update, inefficient resource allocation causes the smartphone to hang, and battery drainage. Such instances may impact the processors handling the network services such that the smartphone is unable to render even the basic network services.

In an instance, the smartphones typically include software to access the numerous services and allow the user to interact with the smartphones. This software typically includes firmware, an operating system, applications, or other software. However, the software of the smartphones often needs to be updated to correct bugs, add features, comply with changes to the wireless telecommunication network, or for other reasons. Such updates are provided wireless to update software or firmware of the smartphone. Unfortunately, the smartphones, while installing software updates, cannot provide the user with access to the services or the events of the wireless telecommunication network. This is so because, the processors may be occupied an overloaded by handling update of software or firmware of the smartphone.

In another instance, the inefficient resource allocation may cause the smartphone to hang. In other example, unavailability of processor resources, infinite looping, deadlock, live lock etc. may be other reasons causing the smartphone to hang. The discontinuation or unresponsiveness of processes of an application in the smartphone may results in the entire system of the smartphone to stuck in a specific state. Whenever hang bugs emerge, the user may not get a response from the application or the smartphone within the expected time, and as a result, the smartphone may freeze.

In another instance, the smartphone may face over paced battery drainage due to factors such as too many push notifications and alerts, multiple applications running in the background and demanding location services, high brightness of the screen, among others. Due to quick batter drainage the user may not be able to avail basic network services such as call, messaging.

The existing technologies lack dynamic solutions to bypass such issues as discussed herein above. The existing techniques discloses suggest scheduling updates, restarting of the smartphone, diverting calls to other devices, etc. Accordingly, there is a need for a system and method to efficiently manage the smartphone resources such that the network services may be availed even when the smartphone is put up with issues as discussed above.

The above information is presented as background information only to assist with an understanding of the disclosure. No determination has been made, and no assertion is made, as to whether any of the above might be applicable as prior art with regard to the disclosure.

### SUMMARY

Embodiments of the disclosure may be able to handle the network services and maintain any incoming telecommunication event.

According to an example embodiment of the disclosure, a method for maintaining a telecommunication event at a user equipment (UE) is disclosed. The method includes: detecting occurrence of an action event at the UE, wherein the action event modifies a capability of functioning of the UE, such that a first processor is unavailable to handle the telecommunication event; reserving a dedicated space in a memory of the UE to handle the telecommunication event upon detection of the action event; establishing interaction between a communication processor and a second processor using the dedicated space such that the telecommunication event received by the communication processor is transmitted to the second processor; and maintaining the telecommunication event.

According to an example embodiment of the disclosure, a system for maintaining a telecommunication event at a user equipment (UE) is disclosed. The system includes: memory storing instructions and at least one processor comprising processing circuitry, wherein the instructions, when executed by the at least one processor individually or collectively, cause the system to: detect occurrence of an action event at the UE, wherein the action event modifies a capability of functioning of the UE such that a first processor is unavailable to handle the telecommunication event; reserve a dedicated space in the memory of the UE to handle the telecommunication event upon detection of the action event; establish interaction between a communication processor and a second processor using the dedicated space such that the telecommunication event received by the communication processor is transmitted to the second processor; and maintain the telecommunication event.

In an example embodiment, a non-transitory computer-readable memory is provided. The non-transitory computer readable memory is provided storing instructions that, when executed by at least one processor of a system, individually and/or collectively, cause the system to: detect occurrence of an action event at the UE, wherein the action event modifies capability of functioning of the UE such that a first processor is unavailable to handle the telecommunication event; reserve a dedicated space in a memory of the UE to handle the telecommunication event upon detection of the action event; establish interaction between a communication processor and a second processor using the dedicated space such that the telecommunication event received by the communication processor is transmitted to the second processor; and maintain the telecommunication event by the second processor.

To further illustrate various advantages and features of the disclosure, a more detailed description will be rendered with reference to various example embodiments thereof, which are illustrated in the appended drawings. It is appreciated that these drawings depict example embodiments of the disclosure and are therefore not to be considered limiting of its scope.

### BRIEF DESCRIPTION OF THE DRAWINGS

These and other features, aspects, and advantages of certain embodiments of the present the disclosure will be more apparent from the following detailed description taken in conjunction with the accompanying drawings in which like reference numerals refer to like elements and, in which:

FIG. 1 is a block diagram illustrating an example environment for the implementation of a system for maintaining a telecommunication event at a user equipment (UE), according to various embodiments;

FIG. 2 is a block diagram illustrating an example configuration of modules/software components of the system for maintaining a telecommunication event at a user equipment (UE), according to various embodiments;

FIG. 3A is a block diagram illustrating an example configuration of a detection module of the system, according to various embodiments;

FIG. 3B is a block diagram illustrating an example configuration of a sub-module of the detection module, according to various embodiments;

FIG. 3C is a block diagram illustrating an example configuration of a sub-module of the detection module, according to various embodiments;

FIG. 3D is a block diagram illustrating an example configuration of a sub-module of the detection module, according to various embodiments;

FIG. 4A is a block diagram illustrating an example configuration of a reservation module of the system, according to various embodiments;

FIG. 4B is a block diagram illustrating an example configuration of the reservation module of the system, according to various embodiments;

FIG. 5 is a block diagram illustrating an example configuration of the system for maintaining the telecommunication event at the UE, according to various embodiments;

FIG. 6 is a flowchart illustrating an example method for maintaining a telecommunication event at a user equipment (UE), according to various embodiments;

FIG. 7 is a diagram illustrating an example use case for maintaining the telecommunication event at the UE, according to various embodiments;

FIG. 8 is a diagram illustrating an example use case for maintaining the telecommunication event at the UE, according to various embodiments; and

FIG. 9 is a diagram illustrating an example use case for maintaining the telecommunication event at the UE, according to various embodiments.

Further, skilled artisans will appreciate that elements in the drawings are illustrated for simplicity and may not have necessarily been drawn to scale. For example, the flowcharts illustrate the method in terms of steps involved to help to improve understanding of aspects of the disclosure. Furthermore, in terms of the construction of the device, one or more components of the device may have been represented in the drawings by conventional symbols, and the drawings may show only those specific details that are pertinent to understanding the various embodiments of the disclosure so as not to obscure the drawings with details that will be readily apparent to those of ordinary skill in the art having the benefit of the description herein.

### DETAILED DESCRIPTION

For the purpose of promoting an understanding of the principles of the disclosure, reference will now be made to the various example embodiments and specific language will be used to describe the same. It will nevertheless be understood that no limitation of the scope of the disclosure is thereby intended, such alterations and further modifications in the illustrated system, and such further applications of the principles of the disclosure as illustrated therein being contemplated as would occur to one skilled in the art to which the disclosure relates.

It will be understood by those skilled in the art that the foregoing general description and the following detailed description are explanatory of the disclosure and are not intended to be restrictive thereof.

Reference throughout this disclosure to “an aspect,” “another aspect” or similar language may refer, for example, to a particular feature, structure, or characteristic described in connection with the various embodiments being included in at least one embodiment of the disclosure. Thus, appearances of the phrase “in an embodiment”, “in another embodiment” and similar language throughout this disclosure may, but do not necessarily, all refer to the same embodiment.

The terms “comprises”, “comprising”, or any other variations thereof, are intended to cover a non-exclusive inclusion, such that a process or method that comprises a list of steps does not include only those steps but may include other steps not expressly listed or inherent to such process or method. Similarly, one or more devices or sub-systems or elements or structures or components proceeded by “comprises . . . a” does not, without more constraints, preclude the existence of other devices or other sub-systems or other elements or other structures or other components or additional devices or additional sub-systems or additional elements or additional structures or additional components.

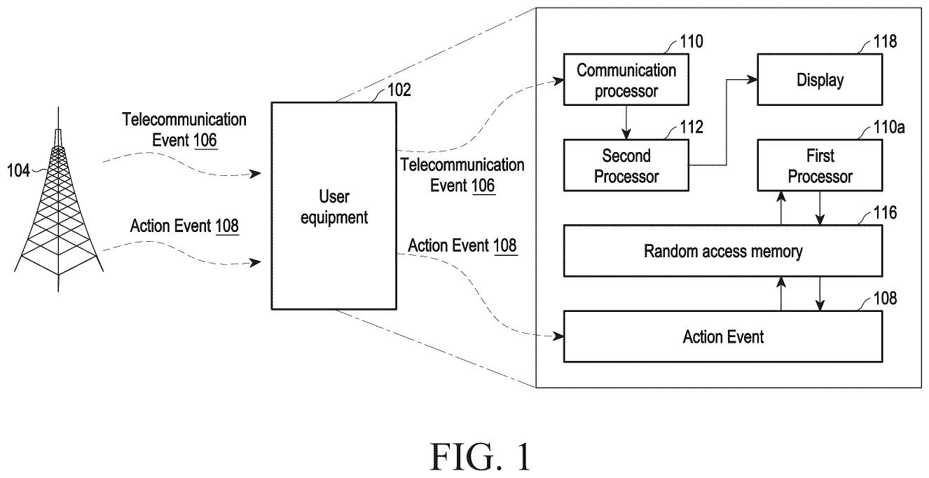

FIG. 1 is a block diagram illustrating an example environment for the implementation of a system 100 for maintaining a telecommunication event 106 at a user equipment (UE) 102, according to various embodiments. For the sake of brevity, the system 100 for maintaining the telecommunication event 106 at the UE 102 is hereinafter interchangeably referred to as the system 100.

In an embodiment, referring to FIG. 1, the system 100 may be implemented in the UE 102, the applications installed in the UE 102 and running on an operating system (OS) of the UE 102 that generally defines a first active user environment. The OS typically presents or displays the application through a graphical user interface (GUI) of the OS. Other applications may be running on the operating system of the UE 102 but may not be actively displayed. In an example, the UE 102 may include, but is not limited to, a laptop computer, a desktop computer, a personal computer (PC), a notebook, a smartphone, a tablet, a smart watch and alike. In the example, the operating system in the UE 102 may be an android operating system.

In an embodiment, the UE 102 is connected to a wireless communication network 104. The UE 102 may be adapted to receive a telecommunication event 106. In an example, the telecommunication event 106 may indicate network services such as voice calls, data exchange, text messaging, Internet access, or other services. A user may be able to access the telecommunication event 106 via the UE 102.

In an embodiment, the UE 102 may receive an action event 108 from the wireless communication network 104. The action event 108 may indicate certain event occurring in the UE 102 and thus consuming resources such as a processor, a battery of the UE 102. In an example, the action event 108 may include a firmware update, a device hang, a low battery. The action event 108 may result in conditions which may be blocking the telecommunication event at the UE 102 such that the telecommunication event may not be maintained on the UE 102. Thus, leading to a state wherein the telecommunication event may not be displayed on the UE 102. Further, as the action event consumes resources of the UE 102, it may also lead to modifying a capability of functioning of the UE 102 such that a first processor 110a is unavailable to handle the telecommunication event.

In an embodiment, the UE 102 may include but is not limited to, a communication processor (e.g., including processing circuitry) 110, a first processor (e.g., including processing circuitry) 110a, a second processor (e.g., including processing circuitry) 112, and a random access memory (RAM) 116, among other components. The communication processor 110, the first processor 110a, and the second processor 112, may be indicative of a type of central processing unit for receiving and executing various commands. The effectiveness of such processors may directly affect every application such as camera, music player, or email program being run on the UE 102. The communication processor 110, the first processor 110a, and the second processor 112, may be in communication with each other. Further, the first processor 110a, and the second processor 112 may be one of, for example, and without limitation, an application processor, a low power processor. For example, the first processor 110a may be the application processor, and the second processor 112 may be the low power processor.

In an example, the communication processor 110 may be configured to support communication between the UE 102 and the wireless communication network 104. Particularly, the communication processor 110a may be configured for making and receiving the telecommunication event 108 over the wireless communication network 104 on the UE 102.

In another example, the first processor 110a being the application processor is configured for the optimal functioning of applications running in the UE 102. For example, the application processor is configured to update the operating system of the UE 102 such that the telecommunication event 108 may not be interrupted. In the example, the first processor 110a may be in communication with the RAM 116. The first processor 110a may be configured to receive the action event 108 and perform action corresponding to the action event 108. In the example, the first processor 110a may perform installing an update of the software or firmware in the UE 102 such that the application processor remains unavailable to handle the telecommunication event and the telecommunication event 106 may be interrupted.

In another example, the second processor 112 being the low power processor may be configured to consume less power and have lower performance than any other processor. For example, the low power processor may be configured to maintain the telecommunication event 106 by attaching a user interface (UI) on a display 118 of the UE 102. In the example, the display may be a screen-off window of the UE 102 such as an always-on display (AOD). The AOD may enable the UE 102 to display limited information while the UE 102 is in an asleep mode. Thus, the low power processor may save significantly on electrical and resource consumption. In the example, the second processor 112 may receive the telecommunication event 108 from the communication processor 110. The second processor 112 may be configured to transmit the telecommunication event 108 to the display 118. In the example, the telecommunication event 108 may be maintained and thus displayed as the AOD via the second processor 112 being the low power processor.

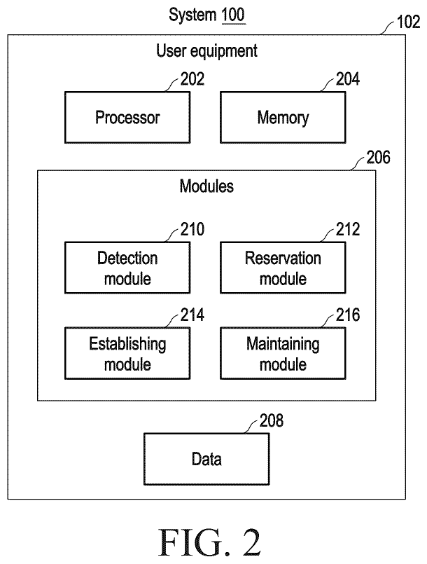

FIG. 2 is a block diagram illustrating an example configuration of modules/software components of the system 100 for maintaining the telecommunication event 106 at the UE 102, according to various embodiments.

The UE 102 may include, but is not limited to, a processor (e.g., including processing circuitry) 202, memory 204, modules (e.g., including circuitry and/or executable program instructions) 206, and data 208. The modules 206 and the memory 204 may be coupled to the processor 202. The processor 202 may one of the communication processor 110, the first processor 110a, and the second processor 112.

The processor 202 may be a single processing unit or several units, all of which could include multiple computing units. The processor 202 may be implemented as one or more microprocessors, microcomputers, microcontrollers, digital signal processors, central processing units, state machines, logic circuitries, and/or any devices that manipulate signals based on operational instructions. Among other capabilities, the processor 202 is adapted to fetch and execute computer-readable instructions and data stored in the memory 204. The processor 202 may include various processing circuitry and/or multiple processors. For example, as used herein, including the claims, the term “processor” may include various processing circuitry, including at least one processor, wherein one or more of at least one processor, individually and/or collectively in a distributed manner, may be configured to perform various functions described herein. As used herein, when “a processor”, “at least one processor”, and “one or more processors” are described as being configured to perform numerous functions, these terms cover situations, for example and without limitation, in which one processor performs some of recited functions and another processor(s) performs other of recited functions, and also situations in which a single processor may perform all recited functions. Additionally, the at least one processor may include a combination of processors performing various of the recited/disclosed functions, e.g., in a distributed manner. At least one processor may execute program instructions to achieve or perform various functions.

The memory 204 may include any non-transitory computer-readable medium known in the art including, for example, volatile memory, such as static random-access memory (SRAM) and dynamic random-access memory (DRAM), and/or non-volatile memory, such as read-only memory (ROM), erasable programmable ROM, flash memories, hard disks, optical disks, and magnetic tapes.

The modules 206, amongst other things, include routines, programs, objects, components, data structures, etc., which perform particular tasks or implement data types. The modules 206 may also be implemented as, signal processor(s), state machine(s), logic circuitries, and/or any other device or component that manipulates signals based on operational instructions.

Further, the modules 206 may be implemented in hardware, instructions executed by a processing unit, or by a combination thereof. The processing unit may comprise a computer, a processor, a state machine, a logic array, or any other suitable devices capable of processing instructions. The processing unit may be a general-purpose processor which executes instructions to cause the general-purpose processor to perform the required tasks or, the processing unit may be dedicated to performing the required functions. In an embodiment of the disclosure, the modules 206 may be machine-readable instructions (software) which, when executed by a processor/processing unit, perform any of the described functionalities.

In an embodiment, the modules 206 may include a detection module 210, a reservation module 212, an establishing module 214 and a maintaining module 216. The detection module 210, the reservation module 212, the establishing module 214 and the maintaining module 216 may be in communication with each other. The data 208 serves, amongst other things, as a repository for storing data processed, received, and generated by one or more of the modules 206.

Referring to FIG. 1 and FIG. 2 the detection module 210 may be adapted to detect occurrence of the action event 108 at the UE 102. The action event modifies the capability of functioning of the UE 102. The detection module 210 may be in communication with the reservation module 212.

In an embodiment, the reservation module 212 may be adapted to reserve a dedicated space in the RAM 116 of the UE 102 to handle the telecommunication event 106 upon detection of the action event 108, such that the first processor 110a is unavailable to handle the telecommunication event. The detection module 210 and the reservation module 212 may be in communication with the establishing module 214.

In an embodiment, the establishing module 214 may be adapted to establish interaction between the communication processor 110 and the second processor 112 using the dedicated space. The interaction between the communication processor 110 and the second processor 112 enables the telecommunication event 106 received by the communication processor 110 to be transmitted to the second processor 112. The detection module 210, the reservation module 212, and the establishing module 214 may be in communication with the maintaining module 216.

In an embodiment, the maintaining module 216 may be adapted to maintain the telecommunication event 106 using the second processor 112 and further display telecommunication event 106.

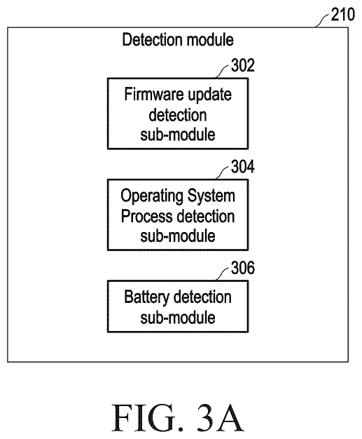

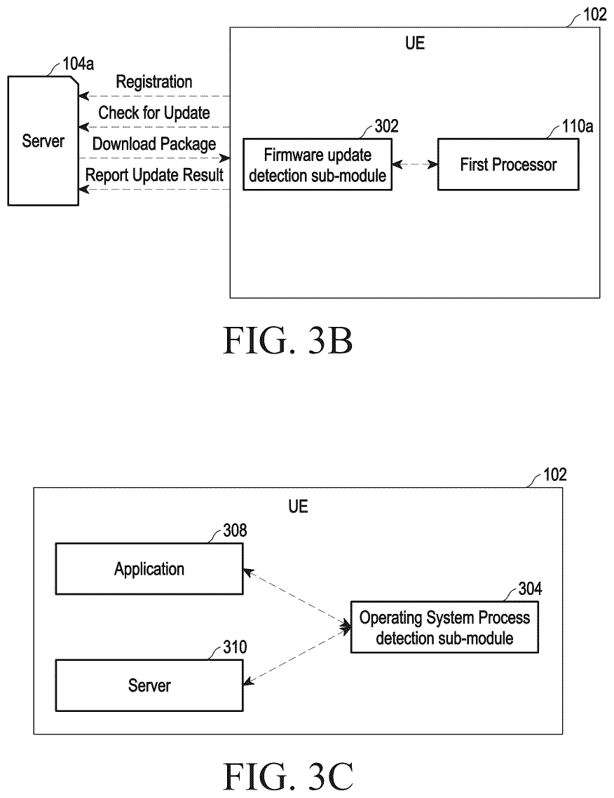

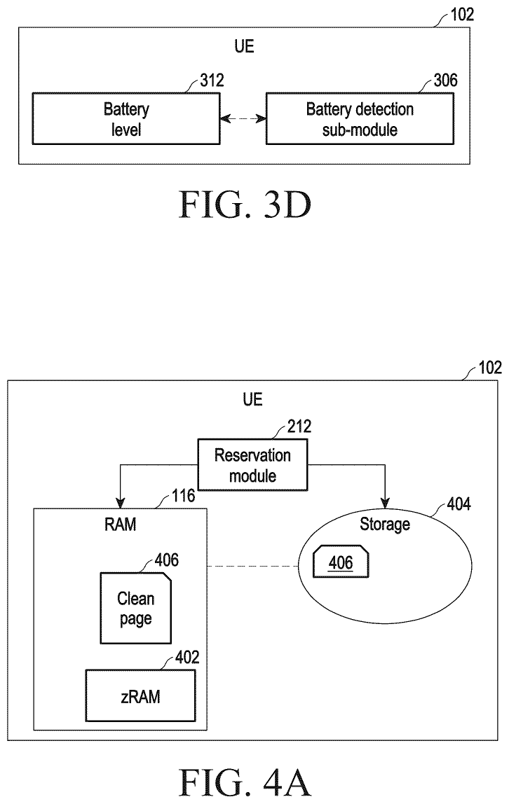

FIG. 3A is a block diagram illustrating an example configuration of the detection module 210 of the system 100, according to various embodiments.

In an embodiment, the detection module 210 may include a Firmware update detection sub-module 302, an operating system process detection sub-module 304, and a Battery detection sub-module 306. Each of the sub-modules may include various circuitry and/or executable program instructions. The detection module 210 may be adapted to detect occurrence of the action event 108, such that the first processor 110a remains unavailable to handle the telecommunication event. Each of the sub-module may detect the action event 108 corresponding to the same. In an example, the action event 108 may include receiving a software or a firmware update over the air (OTA), a hang event of the UE 102, and the low battery of the UE 102. These action event 108 may result in conditions which may be blocking the telecommunication event 106 at the UE 102 such that the telecommunication event 106 received by the communication processor 110 may not be maintained on the UE 102 because the first processor 110a remains unavailable to handle the telecommunication event 106. Thus, the telecommunication event 106 may not be displayed on the UE 102. The sub-modules are adapted to detect each of these action events 108.

FIG. 3B is a block diagram illustrating an example configuration of the sub-module of the detection module 210, according to various embodiments. FIG. 3B may illustrate a server-client communication. For example, the firmware update detection sub-module 302 of the detection module 210 in the UE 102, may include various circuitry and/or executable program instructions and is adapted to detect when there is software update ongoing on the UE 102. In an example, a cloud server 104a in the wireless telecommunication network 104 may be a firmware over-the-air (FOTA) server adapted to update wirelessly an operating firmware of the UE 102. The firmware update detection sub-module 302 may be adapted to register the UE 102 on the cloud server 104a. Further, the firmware update detection sub-module 302 may be adapted to check periodically for updates in the cloud server 104a. As soon as new update or the latest version of the operating firmware is made available in the cloud server 104a the same is downloaded and made available to the UE 102. The operating firmware is then installed in the UE 102 and the firmware update detection sub-module 302 may be adapted to send a report regarding update to the cloud server 104a. In the example, the cloud server 104a may be in communication with the first processor 110a being the application processor. Further, installation of the operating firmware in the UE 102 may engage the application processor. Thus, as the first processor 110a may be engaged in installation of the operating firmware in the UE 102 it may modify capability of functioning of the UE 102 such that the first processor 110a may be unavailable for any other operations, particularly unavailable for handling the telecommunication event 106. And thus, the telecommunication event 106 may not be received by the first processor 110a.

FIG. 3C is a block diagram illustrating an example configuration of a sub-module of the detection module 210, according to various embodiments. For example, FIG. 3C illustrates the operating system process detection sub-module (e.g., including various circuitry and/or executable program instructions) 304. The operating system process detection sub-module 304 may be in communication with an application 308 installed in the UE 102. The operating system process detection sub-module 304 may be adapted to detect when there is UE 102 hang/crash or application not responding (ANR) errors in the UE 102. In an example, the operating system process detection sub-module 304 may be adapted to fetch a state from different android process.

Further, upon detection of hang/crash or ANR errors in the UE 102 by the operating system process detection sub-module 304, the first processor 110a may be engaged in resolving the hang/crash or ANR errors. Thus, as the first processor 110a is consumed due to hang/crash or ANR errors it may modifies capability of functioning of the UE 102 such that the first processor 110a may be unavailable for any other operations. And thus, the telecommunication event may not be received by the first processor 110a.

FIG. 3D is a block diagram illustrating an example configuration of a sub-module of the detection module 210, according to various embodiments. For example, FIG. 3D illustrates the battery level 312 and the battery detection sub-module 306. The battery detection sub-module (e.g., including various circuitry and/or executable program instructions) 306 may be adapted to detect a charging property of the UE 102. In an example, the charging property may include following:
Health: Current battery health for instance cold, dead, good, overheat, over voltage, unknown, or unspecified failure
Status: Current battery status for instance charging, discharging, full, not charging, or unknown)
Level: Current battery level, from zero to maximum
Battery Low: Whether battery is currently low
Temperature: Current battery temperature
Capacity: Remaining battery capacity
Charge Counter: Battery capacity in microampere-hours
Energy Counter: Battery remaining energy in nanowatt-hours

Upon detection of the charging property of the UE 102 that may indicate that current battery level may not be sufficient to power the UE 102, the battery detection sub-module 306 may be adapted to detect such charging property as the action event 108. Such action event 108 may modify capability of functioning of the UE 102 such that the UE 102 may be put to the asleep mode due to low power and thus the first processor 110a is unavailable to handle the telecommunication event 106.

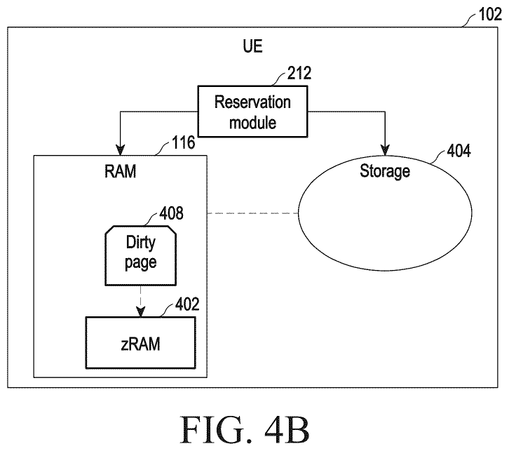

FIG. 4A is a block diagram illustrating an example configuration of the reservation module 212 of the system 100, according to various embodiments.

In an embodiment, the reservation module 212 may be adapted to reserve the dedicated space in the RAM 116 of the UE 102. The dedicated space may be used to handle the telecommunication event 106 upon detection of the action event by the detection module 210. In an example, the UE 102 may include several types of memory such as the RAM 116, a zRAM 402 and a storage 404. In the example, the zRAM 402 may form a partition of the RAM 116 and is adapted for swap space. The storage 404 may be adapted to contain all the persistent data for instance file system and object code for applications, libraries, and platform.

In an embodiment, the reservation module 212 may be adapted to determine whether a reserved memory in the RAM 116 is sufficient for handling the telecommunication event 106. Upon determining that the reserved memory is not sufficient for handling the telecommunication event 108, the reservation module 212 may be adapted to reclaim a clean page 406 from the storage 404. In an example, the clean page 406 may be deleted from the RAM 116 and are instead transferred to the storage 404. In the example, when the reservation module 212 determines a request for the deleted clean page 406, then the clean page 406 may be transferred from the storage 404 to the RAM 116 such that the reserved memory in the RAM 116 may be increased.

FIG. 4B is a block diagram illustrating an example configuration of the reservation module 212 of the system 100, according to various embodiments.

In an embodiment, the reservation module 212 may be adapted to reclaim a dirty page 408 in the RAM 116 to increase the reserved memory in response to determining that the reserved memory is not sufficient for handling the telecommunication event 108. In an example, for reclaiming the dirty page 408 in the RAM 116, the reservation module 212 may be adapted to transfer the dirty page 408 to the zRAM 402 such that count of a free page increases in the RAM thereby increasing the reserved memory.

In an embodiment, the reservation module 212 may be adapted to reserve the dedicated space in the reserved memory for the telecommunication event 106 based on the reclaiming. In an example, the reservation module 212 may be adapted to allocate the dedicated space in the reserved space in the RAM 116 for the second processor 112. In the example, the second processor 112 may use the dedicated space in the RAM 116 for maintaining the telecommunication event 106 without interruption and further the telecommunication event 106 is displayed on the UE 102. In another example, the reservation module 212 may be adapted to allocate an unreserved space in the RAM 116 for the first processor 110a. In the example, the first processor 110a may use the unreserved space to update the operating system of the UE 102 such that the telecommunication event 106 is not interrupted.

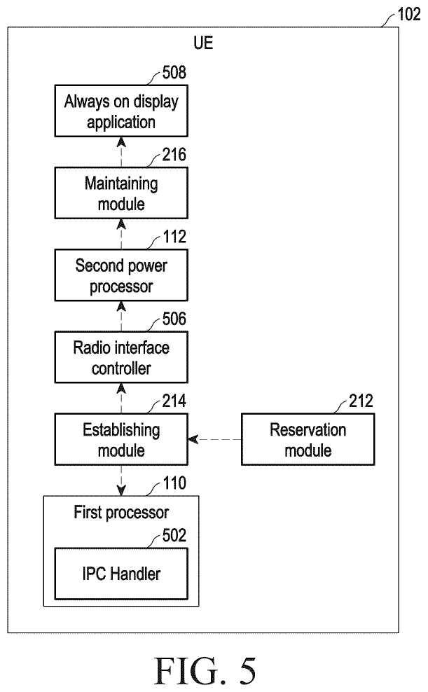

FIG. 5 is a block diagram illustrating an example configuration of the system 100 for maintaining the telecommunication event 106 at the UE 102, according to various embodiments.

In an embodiment, upon reserving the dedicated space in the RAM 116 by the reservation module 212, the establishing module 214 may be adapted to establish communication between the communication processor 110 and the second processor 112. In an example, the establishing module 214 may be adapted to determine a pre-defined inter process communication (IPC) 502 for establishing the communication between the communication processor 110 and the second processor 112. The IPC 502 including an IPC handler and an IPC driver may be adapted to allows the exchange of data between the communication processor 110 and the second processor 112. The IPC 502 may enable resource and data sharing between the communication processor 110 and the second processor 112 without interference.

In an embodiment, a radio interface layer (RIL) controller 506 may be present between the communication processor 110 and the second processor 112. The establishing module 214 may be adapted to establish communication between the communication processor 110 and the second processor 112 using the RIL controller 506. In an example, the RIL controller 506 may be a bridge between a framework services of the operating system such as android of the UE 102 and a hardware such as the communication processor in the UE 102. In the example, the establishing module 214 may be adapted to establish communication between the communication processor 110 and the second processor 112 such that the telecommunication event 106 received at the communication processor 110 may be communicated to the second processor 112, despite the first processor 110a being unavailable to handle the telecommunication event 106. Particularly, the telecommunication event 106 may be the call, the message received by the communication processor 110 is communicated to the low power processor.

In an embodiment, the maintaining module 216 may be adapted to attach the UI of the UE 102 to render the telecommunication event 106 using the second processor 112. In an example, the maintaining module 216 may be adapted to maintain the telecommunication event 106 by transferring the telecommunication event 106 from the RIL controller 506 via the second processor 112 to an always-on display (AOD) application 508. In the example, the AOD 508 may be adapted to attach the UI on the screen-off window of the UE 102. The UI may include the telecommunication event 106 and the screen-off window may indicate that the UE 102 is in the asleep mode. In the example, the AOD application 508 may be adapted to display the telecommunication event 106 on the UI into the screen-off window of the UE 102 such that the UE 102 maintains the telecommunication event 106 by continuously displaying the telecommunication event 106.

The second processor 112 after establishing the connection with the communication processor 110 using the RIL controller 506 receives the telecommunication event 106 through the communication channel of the IPC 502. The maintaining module 216 may be adapted to maintain the telecommunication event 106 using the second processor 112. The telecommunication event 106 is displayed on the AOD application 508 and may not be interrupted by the action events 108 or may not be interrupted due to unavailability of the first processor 110a.

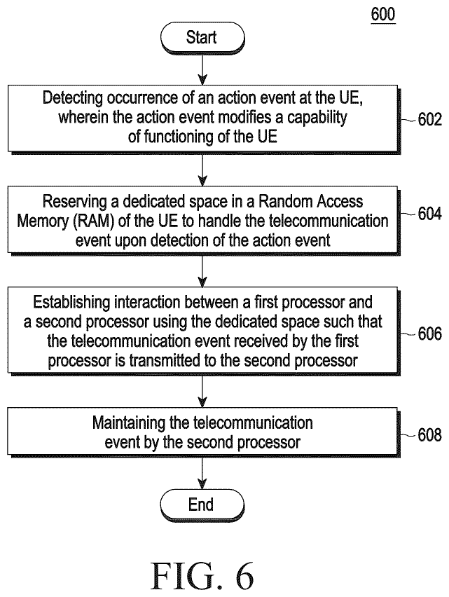

FIG. 6 is a flowchart illustrating an example method 600 for maintaining the telecommunication event 106 at the UE 102, according to various embodiments. The method 600 may be a computer-implemented method executed, for example, by the UE 102 and the modules 206. For the sake of brevity, constructional and operational features of the system 100 that are already explained in the description of FIG. 1, FIG. 2, FIG. 3, FIG. 4, and FIG. 5 are not explained in detail in the description of FIG. 6.

At operation 602, the method 600 may include detecting occurrence of the action event 108 at the UE 102. In the method 600, the action event 108 may include events which may modify capability of functioning of the UE 102 such that the first processor 110a is unavailable to handle the telecommunication event 106. In an example, the action event 108 may be indicative of condition blocking the telecommunication event 106 at the UE 102 including one of the firmware update, the device hang, the low battery.

The method 600 may include the first processor 110a as the application processor and the second processor as the low power processor installed in the UE 102.

At operation 604, the method 600 may include reserving the dedicated space in the Ram 116 of the UE 102 to handle the telecommunication event 106 upon detection of the action event 108 and unavailability of the first processor 110a.

The method 600 may include determining whether the reserved memory in the RAM 116 is sufficient for handling the telecommunication event 106. The method 600 includes reclaiming the clean page 406 and the dirty page 408 in the RAM 116 to increase the reserved memory in response to determining that the reserved memory is not sufficient for handling the telecommunication event 106. Further, the dedicated space is reserved in the reserved memory for the telecommunication event 106 based on the reclaiming.

The reclaiming of the clean page 406 in the method 600 may include, deleting the clean page 406 from the RAM 116 and transferring the clean page 116 from the storage 404 to the RAM 116 upon determining a request for the deleted clean page 406.

The reclaiming of the dirty page 408 in the method 600 may include, transferring the dirty page 408 to the zRAM 402 such that count of a free page increases in the RAM 116.

Thus, reclaiming of the clean page 406 and the dirty page 408 may lead to increase in the free pages or increase the reserved memory. The method 600 includes reserving the dedicated space in the reserved memory for the telecommunication event 106 based on the reclaiming.

Further the method 600 may include allocating the dedicated space in the reserved space in the RAM 116 for the second processor 112 for maintaining the telecommunication event 106 without interruption. The method 600 may include allocating the unreserved space in the RAM 116 for the first processor 110a to update the operating system of the UE 102 such that the telecommunication event 106 is not interrupted.

At operation 606, the method 600 may include establishing interaction between the communication processor 110 and the second processor 112 using the dedicated space such that the telecommunication event 106 received by the communication processor 110 is transmitted to the second processor 112.

The method 600 may include determining the pre-defined inter-process communication (IPC) 502 including the IPC handler and the IPC driver and establishing communication between the communication processor 110 and the second processor 112 using the RIL controller 506 based on the IPC 502.

At operation 608, the method 600 may include maintaining the telecommunication event 106 by the second processor 112.

The method 600 may include attaching the UI into the screen-off window of the UE 102 to render the telecommunication event 106. The screen-off window may be indicative that the UE 102 is in the asleep mode. The method 600 may include maintaining the telecommunication event 106 on the UI 102 into the screen-off window of the UE 102 such that the UE 102 maintain the telecommunication event 106 by continuous display of the telecommunication event 106 using the second processor 112.

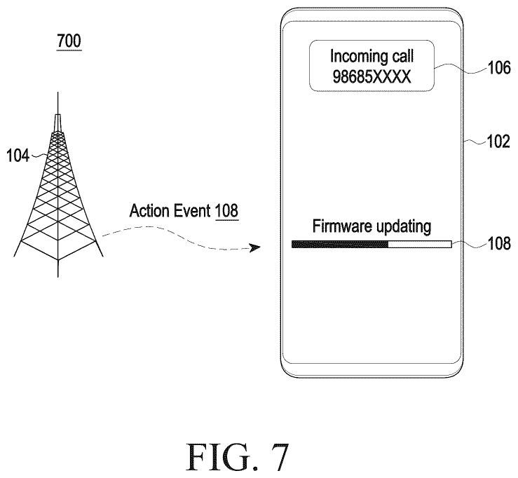

FIG. 7 is a diagram illustrating an example use case 700 for maintaining the telecommunication event 106 at the UE 102, according to various embodiments.

In the example use case 700, the UE 102 may be receiving FOTA from the cloud server 104. Thus, it leads to the action event 108 for instance, the firmware version updating. While the firmware version is downloaded in the UE 102 and consuming resources of the UE 102 such that the application processor is unavailable to handle the telecommunication event 106, the telecommunication event 106 for instance, the call is displayed on the UE 102.

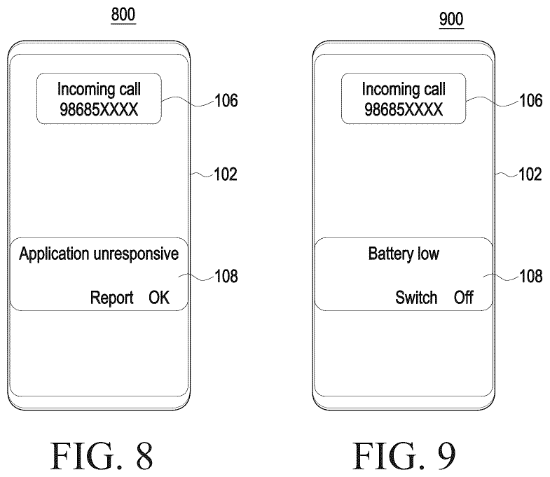

FIG. 8 is a diagram illustrating an example use case 800 for maintaining the telecommunication event 106 at the UE 102, according to various embodiments.

In the example use case 800, the UE 102 counter the action event 108 for instance, the application hang situation thus leading to freeze the applications and working of the UE 102 such that the application processor is unavailable to handle the telecommunication event 106. However, according to various embodiments of the disclosure the telecommunication event 106 for instance, the call is displayed on the UE 102.

FIG. 9 is a diagram illustrating an example use case 900 for maintaining the telecommunication event 106 at the UE 102, according to various embodiments.

In the example use case 900, the UE 102 counter the action event 108 for instance, the battery is completely drained such that the application processor is unavailable to handle the telecommunication event 106. However, according to various embodiments of the disclosure the telecommunication event 106 for instance, the call is displayed on the UE 102.

The disclosure provides various advantages:

The disclosure uses low power processor for handling, maintaining, and displaying the telecommunication event such as incoming Call/SMS. Thus, the disclosure provides the advantages of the Non-A/B update process and requires less memory space in the RAM to be executed.

The disclosure discloses techniques to provide basic network services such as incoming Call/SMS even in the event the UE is updating the firmware.

The disclosure discloses techniques to provide basic network services such as incoming Call/SMS even in the event the UE has low battery.

The disclosure discloses techniques to provide basic network services such as incoming Call/SMS even in the event the UE encounter application hang-up situation.

The disclosure discloses techniques to use resources of the UE efficiently.

While the disclosure has been illustrated and described with reference to various example embodiments, it will be understood that the various example embodiments are intended to be illustrative, not limiting. It will be further understood by those skilled in the art that various changes in form and detail may be made without departing from the true spirit and full scope of the disclosure, including the appended claims and their equivalents. It will also be understood that any of the embodiment(s) described herein may be used in conjunction with any other embodiment(s) described herein.

What is claimed is:

1. A method for maintaining a telecommunication event at a user equipment (UE), the method comprising:
detecting occurrence of an action event at the UE, wherein the action event modifies capability of functioning of the UE such that a first processor is unavailable to handle the telecommunication event;
reserving a dedicated space in a memory of the UE to handle the telecommunication event upon detection of the action event;
establishing interaction between a communication processor and a second processor using the dedicated space such that the telecommunication event received by the communication processor is transmitted to the second processor; and
maintaining the telecommunication event by the second processor.

2. The method of claim 1, wherein the first processor comprise processing circuitry comprising an application processor, and the second processor comprises processing circuitry comprising a low power processor installed in the UE.

3. The method of claim 1, comprising:
allocating the dedicated space in the reserved space in the memory for the second processor for maintaining the telecommunication event without interruption; and
allocating an unreserved space in the memory for the first processor to update an operating system of the UE such that the telecommunication event is not interrupted.

4. The method of claim 1, wherein the action event includes a condition blocking the telecommunication event at the UE including one of a firmware update, a device hang, a low battery.

5. The method of claim 1, wherein reserving the dedicated space in the memory comprises:
determining whether a reserved memory in the memory is sufficient for handling the telecommunication event;
reclaiming one of at least one clean page and at least one dirty page in the memory to increase the reserved memory in response to determining that the reserved memory is not sufficient for handling the telecommunication event; and
reserving the dedicated space in the reserved memory for the telecommunication event based on the reclaiming.

6. The method of claim 5, wherein reclaiming the at least one clean page comprises:
deleting the at least one clean page from the memory; and
transferring the at least one clean page from a storage to the memory upon determining a request for the deleted clean page,
wherein reclaiming the at least one dirty page comprises:
transferring the at least one dirty page to another memory such that count of a free page increases in the memory.

7. The method of claim 1, wherein establishing interaction between the communication processor and the second processor comprises:
determining a specified inter-process communication (IPC) including an IPC handler and an IPC driver; and
establishing communication between the communication processor and the second processor using a radio interface layer (RIL) controller based on the IPC.

8. The method of claim 1, wherein maintaining the telecommunication event comprises:
attaching a user interface (UI) into a screen-off window of the UE to render the telecommunication event wherein the screen-off window indicates that the UE is in an asleep mode; and
maintaining the telecommunication event on the UI into the screen-off window of the UE such that the UE continuously displays the telecommunication event using the second processor.

9. A system for maintaining a telecommunication event at a user equipment (UE), the system comprises:
memory storing instructions; and
at least one processor comprising processing circuitry,
wherein the instructions, when executed by the at least one processor individually or collectively, cause the system to:
detect occurrence of an action event at the UE, wherein the action event modifies a capability of functioning of the UE such that a first processor is not available to support the telecommunication event;
reserve a dedicated space in the memory of the UE to handle the telecommunication event upon detection of the action event;
establish interaction between a communication processor and a second processor using the dedicated space such that the telecommunication event received by the communication processor is transmitted to the second processor; and
maintain the telecommunication event.

10. The system of claim 9, wherein the first processor comprises processing circuitry comprising one of an application processor and the second processor comprises processing circuitry comprising a low power processor installed in the UE,
wherein the action event includes a condition blocking the telecommunication event at the UE including one of a firmware update, a device hang, a low battery.

11. The system of claim 9, wherein the instructions, when executed by the at least one processor individually or collectively, cause the system to:
allocate the dedicated space in the reserved space in the memory for the second processor for maintaining the telecommunication event without interruption and
allocate an unreserved space in the memory for the first processor to update an operating system of the UE such that the telecommunication event is not interrupted.

12. The system of claim 9, wherein the instructions, when executed by the at least one processor individually or collectively, cause the system to:
determine whether a reserved memory in the memory is sufficient for handling the telecommunication event;
reclaim one of at least one clean page and at least one dirty page in the memory to increase the reserved memory in response to determining that the reserved memory is not sufficient for handling the telecommunication event; and
reserve the dedicated space in the reserved memory for the telecommunication event based on the reclaiming.

13. The system of claim 12, wherein the instructions, when executed by the at least one processor individually or collectively, cause the system to: delete the at least one clean page from the memory; and
transfer the at least one clean page from a storage to the memory upon determining a request for the deleted clean page,
wherein for reclaiming the at least one dirty page, the instructions, when executed by the at least one processor individually or collectively, cause the system to: transfer the at least one dirty page to another memory such that count of a free page increases in the memory.

14. The system of claim 9, wherein the instructions, when executed by the at least one processor individually or collectively, cause the system to:
determine a specified inter-process communication (IPC) including an IPC handler and an IPC driver; and
establish communication between the communication processor and the second processor using a radio interface layer (RIL) controller based on the IPC.

15. The system of claim 9, wherein the instructions, when executed by the at least one processor individually or collectively, cause the system to:
attach a user interface (UI) into a screen-off window of the UE to render the telecommunication event wherein the screen-off window indicates that the UE is in an asleep mode; and
maintain the telecommunication event on the UI into the screen-off window of the UE such that the UE continuously displays the telecommunication event using the second processor.

16. A non-transitory computer-readable storage medium storing one or more programs comprising instructions to, when executed by at least one processor of a system individually or collectively, cause the system to:
detect occurrence of an action event at the UE, wherein the action event modifies a capability of functioning of the UE such that a first processor is not available to support the telecommunication event;
reserve a dedicated space in a memory of the UE to handle the telecommunication event upon detection of the action event;
establish interaction between a communication processor and a second processor using the dedicated space such that the telecommunication event received by the communication processor is transmitted to the second processor; and
maintain the telecommunication event.

17. The non-transitory computer-readable storage medium of claim 16, wherein the first processor comprises processing circuitry comprising one of an application processor and the second processor comprises processing circuitry comprising a low power processor installed in the UE,
wherein the action event includes a condition blocking the telecommunication event at the UE including one of a firmware update, a device hang, a low battery.

18. The non-transitory computer-readable storage medium of claim 16, wherein the instructions, when executed by the at least one processor individually or collectively, cause the system to:
allocate the dedicated space in the reserved space in the memory for the second processor for maintaining the telecommunication event without interruption and
allocate an unreserved space in the memory for the first processor to update an operating system of the UE such that the telecommunication event is not interrupted.

19. The non-transitory computer-readable storage medium of claim 16, wherein the instructions, when executed by the at least one processor individually or collectively, cause the system to:
determine whether a reserved memory in the memory is sufficient for handling the telecommunication event;
reclaim one of at least one clean page and at least one dirty page in the memory to increase the reserved memory in response to determining that the reserved memory is not sufficient for handling the telecommunication event; and
reserve the dedicated space in the reserved memory for the telecommunication event based on the reclaiming.

20. The non-transitory computer-readable storage medium of claim 16, wherein the instructions, when executed by the at least one processor individually or collectively, cause the system to:
determine a specified inter-process communication (IPC) including an IPC handler and an IPC driver; and
establish communication between the communication processor and the second processor using a radio interface layer (RIL) controller based on the IPC.
